(19) United States
(12) Patent Application Publication
(10) Pub. No.: US 2006/0175203 A1
(43) Pub. Date: Aug. 10, 2006

(54) Electroplating pcb components

(75) Inventors: Timothy J. Davis, Clayton Victoria (AU); Breet Sexton, Clayton Victoria (AU)

Correspondence Address: CONNOLLY BOVE LODGE & HUTZ LLP, SUITE 800, 1990 M STREET NW, WASHINGTON, DC, 20036-3425, US

(73) Assignee: Micro Relay Holdings Pty Ltd., Hawthorn (AU)

(21) Appl. No.: 10/548,277

(22) PCT Filed: Mar. 8, 2004
(86) PCT No.: PCT/AU04/00280

§ 371 Date: Sep. 9, 2005

(30) Foreign Application Priority Data
Mar. 10, 2003 (AU) 2003901058

(51) Int. Cl. H01R 13/02; C25D 5/10

(52) U.S. Cl. 205/170; 439/886

(57) ABSTRACT

Curved out of plane metal components are formed on PCB substrates (11) by electroplating two layers (13, 14) of the same metal such that each layer has a different internal stress. This produces as curvature of the layer (13, 14) which enables coils, curved cantilever beams and springs to be fabricated. The amplitude and direction of curvature can be controlled by controlling the stress and thickness of each layer. The stress is controlled by controlling the composition of the electroplating bath.

This invention relates to a method of forming shaped out of plane components on PCB substrates.

### BACKGROUND TO THE INVENTION

Printed circuit boards are known as a means of providing electrical interconnection between electronic components. Basically a PCB consists of an insulating substrate, commonly made of an epoxy resin fibreglass, coated with a conductive layer, usually copper, affixed to one or both sides. A circuit design engineer will determine the layout of the components and the required conductive interconnections, and the pattern of interconnections will be etched on the PCB, usually using a photomask to protect the selected connection paths from the etchant. The result is an insulating carrier board with a pattern of copper tracks defining the interconnections between the electronic components to be affixed to the board.

Multi-layer PCBs are also known, in which additional copper tracks are incorporated between two or more insulating layers. There may be many such layers. The tracks on different layers can be connected by the use of through-holes, called vias, which may be plated-through to provide electrical connection between the layers. PCB manufacturing facilities commonly use photo lithography, laminating and electroplating which are relatively inexpensive methods.

Patent specification PCT/AU02/01438 disclosed a method of forming a three dimensional structure such a cantilevered beam relay switch using PCB fabrication techniques. In some embodiments of that relay the cantilever beam is preferably curved away from the supporting substrate.

Patent specification WO03/066515 discloses fabrication of electromechanical devices using deposition and undercut etching processes.

There is also a need in PCB fabrication to be able to fabricate springs and coils which require that a curved metal part is formed.

U.S. Pat. No. 6,392,524 discloses a method of forming curved out of plane elements on silicon IC chips using sputtering to deposit films with a built in stress gradient. European patent 1245528 discloses an implantable flexible structure in which stress is controlled by thickness control.

Specification WO 02/067293 discloses a MEMS device with bowed arms in which the bowing is achieved by heat and different expansion coefficients or during fabrication by etching into a bowed shape.

These are MEMS devices and are not suitable for fabrication by less expensive techniques such as electroplating.

It is an object of this invention to provide a method of forming curved out of plane components using PCB methods.

### BRIEF DESCRIPTION OF THE INVENTION

To this end the present invention provides a method of forming curved components which includes the steps of electroplating a predetermined thickness of first metal layer with a predetermined internal stress value and then electroplating a second layer with a different internal stress value and optionally a different thickness.

By selecting the difference in stress and thickness a predetermined degree of curvature can be imparted to the electroplated component.

It has long been known that electroplating can impart a tensile or compressive stress to a deposited metal layer. However this was seen as a problem that needed to be corrected and most attention was paid to developing electroplating techniques where zero internal stress was created. European patent 1063324 teaches the parameters that determine stress in thin electroplated metal layers. The aim of the technique taught in that patent is to achieve near zero stress by varying plating temperature and current density.

A preferred metal for use in this invention is Nickel.

Nickel electroplated onto substrates in plating applications is subject to internal stress. This is well documented and e.g. it is know that the stress can be either compressive, tensile or zero depending on the plating conditions. Examples of tensile baths include the Watts Nickel bath, and example of a near-zero stress bath is the sulphamate nickel bath. Compressive stress can be induced in the Watts bath by adding “brighteners”, or organic addition agents. This is commonly called “Bright Nickel”

Single layers of nickel plated onto stainless steel, a common test substrate, when peeled off for examination, usually display curvature, which is usually “away” from the substrate in the case of highly tensile baths, and “towards” the substrate in the case of compressively stressed baths. In most cases this results from a stress gradient in the plated material perpendicular to the surface as the layers build up. A constant tensile stress in a thin plate cannot cause curvature.

Controlled curvature may be induced in small cantilevers, beams and MEMS type parts made form electroplated nickel. The Curvature may be towards the substrate, zero or away from the substrate, and can be predicted.

The plated parts have at least two layers of the same metal, such as nickel plated on top of each other, where each layer has a different internal stress, either compressive, tensile or zero. The different stress can be changed by changing the type of nickel plating bath, or altering the constituents of a single bath e.g by varying the nickel chloride content of a Watts bath.

If anchored at one end onto the surface, the release nickel part curves upwards, downwards or is flat, and behaves like a spring. It can be used for contacting or switching.

The degree of curvature can also be changed by varying the thickness of each layer plated. This results in a continuous change in curvature up to a maximum determined by the intrinsic stress in each layer.

The curvature displayed in predominantly on one dimension for thin rectangular-shaped parts. For circular parts, for example, a two dimensional curved surface results, which could be used for making, micro-mirrors for example, either concave or convex.

More complex three-dimensional structures can be built up after release of the plated material form the underlying surface. For example, self assembling coils can be released from a copper substrate by plating up to three layers with alternating areas of upward and downward curving nickel.

Both upward and downward curving beams can be manufactured using just two nickel baths, one with a zero stress (ie Nickel Sulphamate) and one with a tensile stress (le Watts bath). By reversing the layers, opposite curvature is achieved.

To form a curved component the process requires releasing the plated nickel from the surface, by dissolution of the underlying substrate (eg in the case of copper as a substrate)

By anchoring various parts of the nickel structure to the underlying substrate, MEMS elements may be constructed, ie switches and relays.

This process is not restricted to nickel and applies equally to other metals where the plating baths display a variation in the intrinsic plated stress of at least two different values.

It is also possible to use a single nickel bath and change the plating conditions, e.g the current density, during plating to deposit layers with different stress levels.

### DETAILED DESCRIPTION OF THE INVENTION

Preferred embodiments of the invention will be described with reference to the drawings in which:

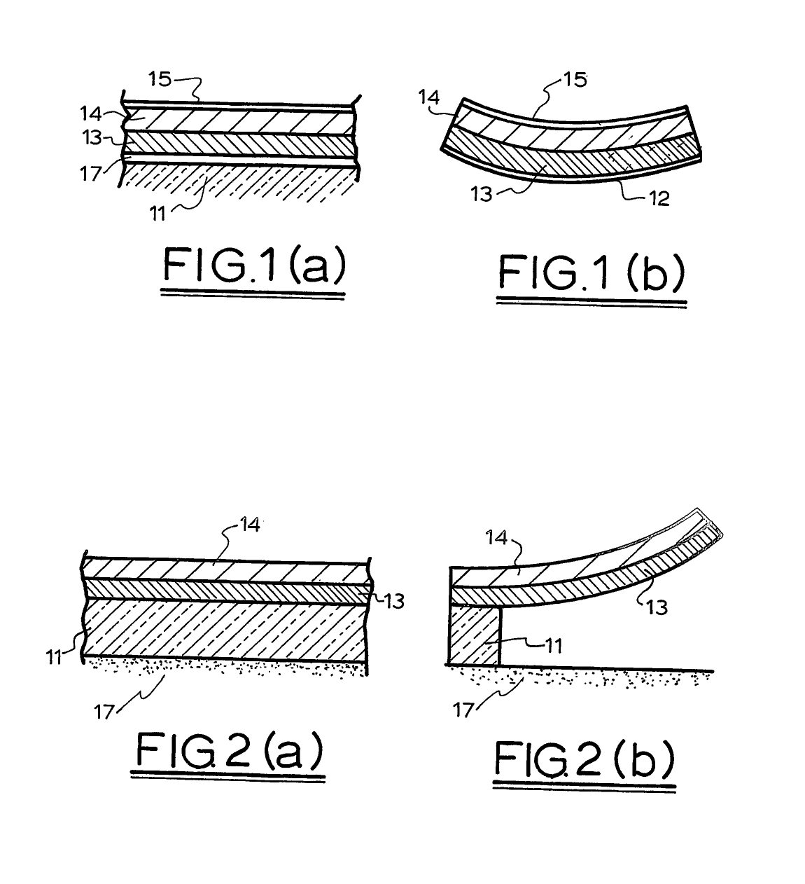

FIG. 1 illustrates the method of forming an upwardly curving component;

FIG. 2 illustrates the method of forming an upwardly curving component which is anchored at one end;

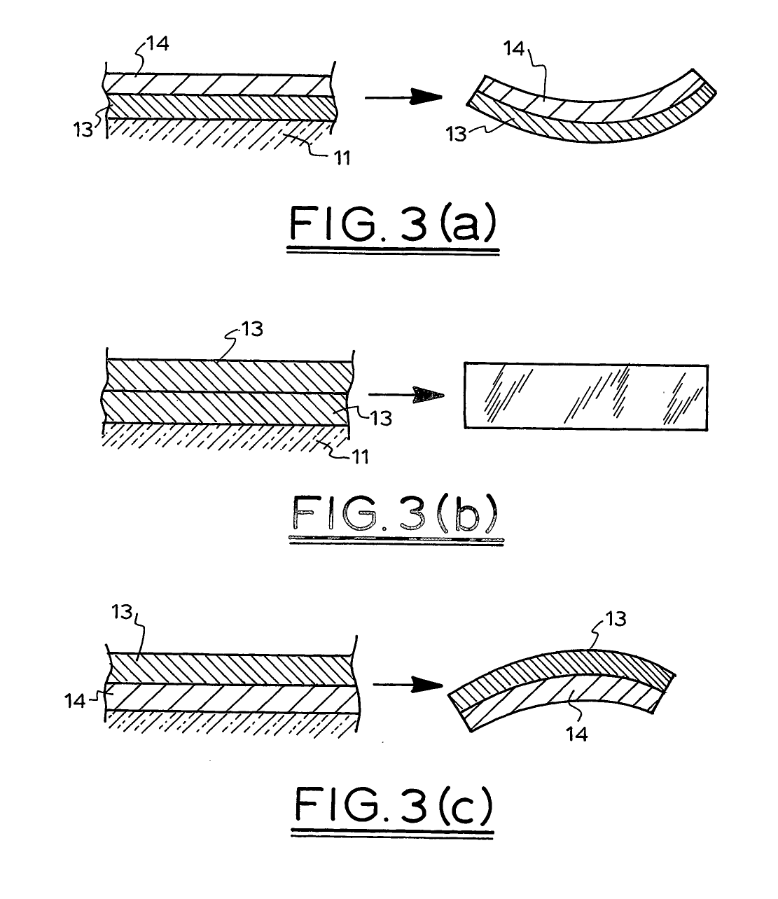

FIG. 3 illustrates methods of controlling curvature direction in components;

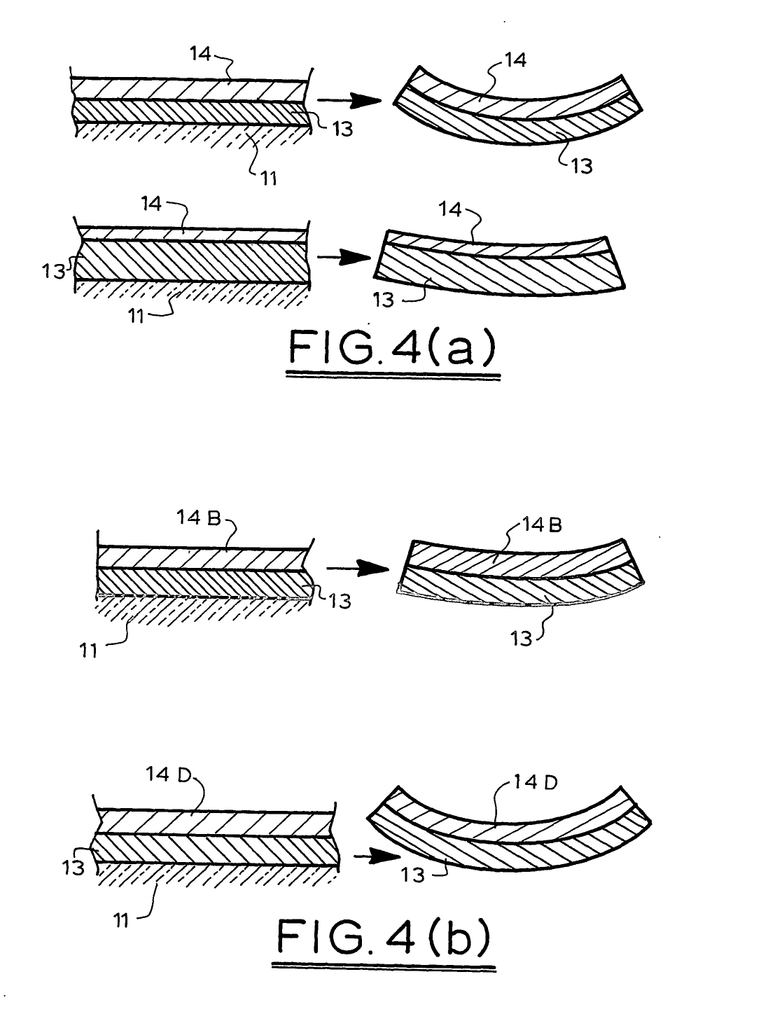

FIG. 4 illustrates methods of controlling curvature amplitude in components;

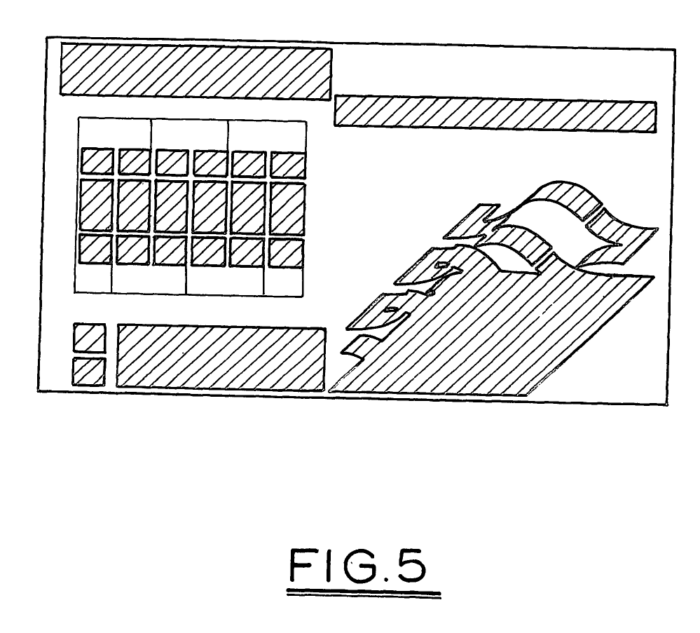

FIG. 5 illustrates a self erecting coil according to this invention.

The method of this invention produces varying stress levels in electro deposited metals by controlling the bath composition. The present invention is illustrated with reference to electrodeposited nickel.

There are various nickel plating bath compositions which can impart different stress values to the electrodeposited nickel layer. Plating bath compositions and processes are well documented in the literature for example:
1. L. J. Durney, Editor, “Electroplating Engineering Handbook” Fourth Edition, Chapman and Hall (1996)
2. J. K. Dennis and T. E. Such, “Nickel and Chromium Plating”, 3^{rd} edition, 1993, Woodhead Publishing, Cambridge, UK.
3. S. Alec Watson, “Compendium of Nickel Electroplating and Electroforming”, Nickel Development Institute.
4. “The Electrodeposition of Nickel”, Falconbridge, Ltd. (1993)

A. Zero, or Low Tensile Stress. Sulphamate Nickel bath

Composition: 450 g/l Ni Sulphamate, 30 g/l boric acid, 0.4 g/l non-pitting agent

Temperature 50 C

B. Low Tensile Stress Watts Nickel Bath

Composition: 300 g/l Nickel Sulphate, 45 g/l Nickel Chloride, 35 g/l boric acid

Temperature 50 C

C. Medium Tensile Stress High Chloride Watts Nickel Bath

Composition: 240 g/l nickel sulphate, 90 g/l nickel chloride, 35 g/l boric acid

Temperature 50 C

D. High Tensile Stress: All Chloride Nickel Bath

Composition: 240 g/l nickel chloride, 30 g/l boric acid

Temperature 50 C.

Typical Tensile stress values for the above baths are as follows:

Bath A Sulphamate 0-55 MPa (megapascals)

Bath B Watts 110 MPa

Bath C High chloride Watts 210 MPa

Bath D All chloride bath 310 MPa

The above baths are commonly used commercial bath formulations.

By varying the chloride content of the Watts bath, other baths of intermediate compositions can also be used to get customised stress values for particular applications.

With reference to FIG. 1 the upward bending beam is fabricated on a substrate 11 which is preferably copper the sequentially electroplated layers are an optional gold layer 12 a Nickel layer 13 of low or zero tensile stress as formed in bath A, a stressed Nickel layer 14 as formed in any one of baths B, C, or D and finally an optional gold layer 15. when released from the substrate as shown in FIG. 1b the beam curves upwardly. In FIG. 2 the same beam without the gold layers is shown except that in releasing the beam from the substrate 11 only part of the substrate is etched away to leave one end anchored to form an upwardly curved cantilever beam mounted on a PCB board 17 as shown in FIG. 2b.

In FIG. 3 three methods are illustrated. FIG. 3a shows the upwardly bending method with the higher stressed layer on top; FIG. 3b shows two identically stressed layers to provide a straight beam; and in FIG. 3c the stressed layer 14 from baths B C or D is deposited first followed by the low or zero stressed layer 13 from bath A.

### EXAMPLE 1

A copper substrate, typically 35 micron thick copper foil, commonly used in circuit board manufacture is cleaned by dipping in 5% sulphuric acid solution. The copper sheet is then laminated with dry film photoresist and patterned using a conventional photomask. The photomask has patterns delineating the shapes required for the final electroplated components.

The copper sheet may be optionally temporarily attached to an underlying prefabricated circuit board by a removable adhesive layer. Using photolithography, holes can be photoetched into the copper to align with points on the circuit board. These holes can be later electroplated through to act as anchor points for the released MEMS components fabricated by the following stressed plating technique.

(Upwardly Bending Component) Refer to FIGS. 1 and 2

1. The copper sheet with dry film photo developed layer is dipped in a 5% sulphamic acid and rinsed in water to activate the copper prior to electroplating.
2. Optionally, a 0.5 micron thick gold layer 12 is applied by electroplating in a conventional hard gold plating solution (FIG. 1(a))
3. A typically 5-20 micron thick layer 13 of zero stress nickel plating is applied by plating in bath A, Sulphamate Nickel, at a current density of 1.5-2 amperes per square decimetre, for a period of 10-60 minutes.
4. A second 5-20 micron thick layer 14 of tensile stressed nickel form baths B, C or D is then electroplated over the first nickel layer, at a current density of 1.5-2 amperes per square decimetre, for 10-60 minutes.
5. Optionally, a final thin gold layer 15, typically 0.5 microns of hard gold can be electroplated over the final nickel layer.
6. The dry film resist layer is stripped form the surface of the plated assembly by soaking in 3% sodium hydroxide solution.
7. The underlying copper sheet is then dissolved in an etchant solution consisting of 250 g/l of ammonium persulphate in water at 50 C for 1-2 hours.
8. The result is MEMS components which, when freed by dissolution of the copper, bend away from the surface (see FIG. 1(b)). FIG. 3a) illustrates this for a bilayer of Nickel with different stress levels.
9. If one end of the component is anchored to the underlying circuit board or other substrate, the components will remain on the underlying substrate and bend upwards, exhibiting a spring-like behavior (FIG. 2b) without optional gold layers.
10. Gold electroplating has typically zero stress in thin layers and does not affect the resultant curvature of MEMS parts if the plating thickness is less than one micron.

### EXAMPLE 2

Making a Flat Component

This example is identical to that described in example 1 above, except that step 4 is omitted, ie no second layer of nickel is applied.

When released, components are parallel to the substrate, exhibiting no curvature. Refer to FIG. 3b)

### EXAMPLE 3

Making a Downward-Curving Component

This example is identical to example 1, except the plating sequence is reversed. The first nickel plated layer in step 3 is plated from any of the baths B, C or D, ie Watts, Medium Chloride or All chloride, and Step 4 is plated from bath A, Sulphamate.

The curvature of this component will be convex, towards the surface. Refer to FIG. 3 C

### EXAMPLE 4

Other Methods of Producing Curved Components (Refer to FIG. 4)

The following methods can also be used to control the curvature of metal plated MEMS components using the different stress plating baths A-D.
Varying the curvature of a part by changing the ratio of the thicknesses of the two plated layers. (FIG. 4a)
Plating any two nickel layers which have different intrinsic stress levels, ie plating from baths A-B, B-C, C-D, A-C, A-D, C-A, . . . etc. (FIG. 4(b) which illustrates the stressed layer 14b using Bath B to produce the curved product C1 and using bath D to provide layer 14d to produce a more curved product C2
Plating more than two layers, ie ACD to produce different stress effects
Use of a compressively stressed nickel bath, “E”, for example Bright Nickel, in combination with baths A-D to produce higher levels of bending.
Use of intermediate bath compositions between those listed in B-D, particularly by varying the nickel chloride level.

### EXAMPLE 5

Producing Individual MEMS Components with Controlled Curvature, not Attached to the Substrate.

The process of this invention may also be used to produce large numbers of MEMS components, e.g. micro-cantilevers or switches, which have controlled curvature and can be assembled into other structures at a later date.
1. A planar stainless steel sheet is passivated in dichromate solution and patterned with a dry film resist to produce the shapes required for electroplating.
2. Controlled stress electroplating by the method described in 2 above is applied. Optionally, 0.5 microns of hard gold can be applied before and after the nickel plating to protect the parts from corrosion.
3. With the dry film resist stripped off, the individual MEMS components can be removed from the stainless steel substrate by vacuum suction with a pick and place tool, ready for insertion, spotwelding or laser attachment to a micromachine.
4. This method has the advantage of producing large numbers of parts on a planar substrate. The adhesion of plated nickel or gold to stainless steel is weak and allows later removal from the template without chemical dissolution.

### EXAMPLE 6

Micropatterning of Alternating Upward and Downward Curving Areas to Produce Three Dimensional Structures after Release.

FIG. 5 shows the concept of electroplating micropatterned areas of a substrate with alternating sections of AB plating where A is bath A and B, bath B together with BA sections adjoining.

After release by copper dissolution or other methods of freeing form the substrate, a self-assembling coil can be manufactured, where the alternating controlled stress regions provide opposite curvature.

Those skilled in the art will realize that other examples of three dimensional forms may be produced by micropatterning.

From the above it can be seen that the present invention provides a unique method of forming curved components by electroplating which can be applied in the manufacture of a range of components. Those skilled in the art will also realize that the invention may be implemented in ways other than those described without departing from the core teachings of the invention.

1. A method of forming curved components which includes the steps of electroplating a predetermined thickness of a first metal layer with a predetermined internal stress value and then electroplating a second layer with a different internal stress value and optionally a different thickness.

2. A method as claimed in claim 1 in which the metal is Nickel.

3. A method as claimed in claim 1 in which a first metal layer is formed with low stress onto a removable substrate and a second metal layer with a higher stress is formed on said first metal layer and the substrate is removed to form an upwardly curving component.

4. A method as claimed in claim 1 in which a first metal layer is formed with predetermined stress onto a removable substrate and a second metal layer with a lower stress is formed on said first metal layer and the substrate is removed to form a downwardly curving component.

5. A method as claimed in claim 1 in which the thickness of the higher stressed layer is varied compared to the lower stressed layer to vary the degree of bending in the combined layers.

6. A method as claimed in claim 1 in a series of adjacent layers are electro deposited with alternating stress levels onto a substrate and then a series of second layers with alternating stress levels to the first layers are plated so that on release from the substrate a self supporting coil is formed.

7. A printed circuit board which includes an electroplated component produced by the method of claim 1.
